(19) United States
(12) Patent Application Publication
(10) Pub. No.: US 2010/0107082 A1
(43) Pub. Date: Apr. 29, 2010

(54) COMMENT DELIVERY SYSTEM, TERMINAL DEVICE, COMMENT DELIVERY METHOD, AND RECORDING MEDIUM STORING PROGRAM THEREFOR

(75) Inventor: Ryuichiro Ban, Funabashi-shi (JP)

Correspondence Address: CANTOR COLBURN, LLP, 20 Church Street, 22nd Floor, Hartford, CT, 06103, US

(73) Assignee: DWANGO CO., LTD., Tokyo (JP)

(21) Appl. No.: 12/532,033

(22) PCT Filed: Mar. 26, 2008
(86) PCT No.: PCT/JP2008/055740

§ 371 Date: Sep. 18, 2009

(30) Foreign Application Priority Data
Mar. 30, 2007 (JP) 2007-094846
Sep. 20, 2007 (JP) 2007-244328

(51) Int. Cl. G06F 17/00; G06F 3/048; G06F 15/16

(52) U.S. Cl. 715/733; 700/94

(57) ABSTRACT

A comment delivery server associates comment contents in which an elapsed contents playback time has been set as a comment attachment time with contents identification information, and stores these as comment information. The comment delivery server reads from a comment information storage section comment information which corresponds to contents identification information received by a contents identification information receiving section, and delivers it to a terminal device. The terminal device transmits identification information for contents targeted for playback to the comment delivery server, receives comment information transmitted from the comment delivery server, and stores the received comment information. Of the comment information stored in the comment information storage section, comments to which have been assigned a comment attachment time which corresponds to an elapsed contents playback time for the contents being played back are displayed so as to be synchronized with the elapsed contents playback time of the contents being played back.

### CROSS REFERENCE

This is a U.S. national stage of application No. PCT/JP2008/055740, filed on 26 Mar. 2008. Priority under 35 U.S.C. §119(a) and 35 U.S.C. §365(b) is claimed from Japanese Application Nos. 2007-094846, filed 30 Mar. 2007, and 2007-244328, filed 20 Sep. 2007, the disclosures of which are also incorporated herein by reference.

### TECHNICAL FIELD

The present invention relates to a comment delivery system, a terminal device, a comment delivery method, and a recording medium storing a program therefore, which are able to refer to comments relating to music contents or moving picture contents which are being played while playing the contents.

Priority is claimed on Japanese Patent Application Nos. 2007-94846, filed Mar. 30, 2007 and 2007-244328, filed Sep. 20, 2007, the contents of which are incorporated herein by reference.

### BACKGROUND ART

Conventionally, various types of player are used in order to play music. These players include, for example, PCs (personal computers) and portable music players. In addition to audio output sections which play and output music, these devices also have display screens and are able to display various types of menu screens, the title and artist name for a piece of music currently being reproduced, the play time, and the like. Moreover, a waveform pattern which corresponds to the frequency components of the audio in the music being played is also displayed (see, for example, Patent document 1).

According to this type of terminal device, a user is able to ascertain the title, artist name and the like of a piece of music being played.
[Patent document 1] Japanese Patent Application, First Publication (JP-A) No. H08-9285

### DISCLOSURE OF THE INVENTION

### Problems to be Solved by the Invention

However, in a terminal device of the above-described conventional technology, all it is possible to do is to simply view the title and artist name and the like of a piece of music being played, or view a waveform pattern which corresponds to the music piece. Accordingly, it is desirable for a new way of enjoying music which is not currently available to be provided by using information other than that described above.

The present invention was conceived in view of the above described circumstances and it is an object thereof to provide a comment delivery system, a terminal device, a comment delivery method, and a recording medium storing a program therefore which make it possible to enjoy music using music and images.

Moreover, it is a further object of the present invention to provide a comment delivery system, a terminal device, a comment delivery method, and a recording medium storing a program therefore which make it possible to enjoy not only music, but also moving pictures and audio by combining images with the moving pictures and audio.

### Means for Solving the Problem

In order to solve the above described problems, according to the present invention, a comment delivery system includes a comment delivery server which delivers comments relating to music and a terminal device, the comment delivery server including: a comment information storage section which stores, as comment information, comment contents and a comment attachment time which represents the time when the comment contents are attached by using an elapsed music playback time from the time when playback of the piece of music started, the comment information being stored in association with music identification information for a piece of music; a music identification information receiving section which receives the music identification information transmitted from the terminal device; a comment information reading section which reads from the comment information storage section comment information associated with the music identification information which is received by the music identification information receiving section; and a comment information delivery section which delivers the comment information read by the comment information reading section to the terminal device which transmits the music identification information, and the terminal device comprising: a music identification information transmitting section which transmits the music identification information for a piece of music targeted for playback to the comment delivery server; a comment information receiving section which receives the comment information transmitted from the comment delivery server; a comment information storage section which stores the comment information received by the comment information receiving section; and a display unit which displays the comment contents associated with a point in time indicated by the comment attachment time based on the comment information stored in the comment information storage section so as to be synchronized with the elapsed music playback time of the piece of music being played.

In the comment delivery system of the present invention, it is also possible for the music identification information to be either one of identification information stipulated on the basis of waveform information formed by audio components contained in the piece of music, or identification information obtained by combining the title of the piece of music and artist name of the piece of music.

In the comment delivery system of the present invention, it is also possible for the comment delivery server to store comment information in the comment information storage section when this comment information is transmitted from the terminal device, and deliver it to the terminal device using the comment information delivery section, and for the terminal device to receive the comment information via the comment information receiving section each time this comment information is transmitted from the comment information delivery section, and to then store it in the comment information storage section, and then read and display it in accordance with the elapsed music playback time of the music.

Moreover, according to the present invention, a comment delivery system includes a comment delivery server which delivers comments relating to contents and a terminal device, the comment delivery server comprising: a comment information storage section which stores, as comment information, comment contents and a comment attachment time which represents the time when the comment contents are attached by using an elapsed contents playback time from the time when playback of the contents started, the comment information being stored in association with contents identification information for contents; a contents identification information receiving section which receives the contents identification information transmitted from the terminal device; a comment information reading section which reads from the comment information storage section comment information associated with the contents identification information which is received by the contents identification information receiving section; and a comment information delivery section which delivers the comment information read by the comment information reading section to the terminal device which transmits the contents identification information, and the terminal device comprising: a contents identification information transmitting section which transmits the contents identification information for contents targeted for playback to the comment delivery server; a comment information receiving section which receives the comment information transmitted from the comment delivery server; a comment information storage section which stores the comment information received by the comment information receiving section; and a display unit which displays the comment contents associated with a point in time indicated by the comment attachment time based on the comment information stored in the comment information storage section so as to be synchronized with the elapsed contents playback time of the contents being played.

In the comment delivery system of the present invention, it is also possible for the contents to be program data broadcast from a broadcasting station, and for the contents identification to be program identification information which identifies the program data, and which is transmitted together with the program data.

In the comment delivery system of the present invention, it is also possible for the contents to be moving picture data which is read from a recording medium by the terminal device, or is received from a moving picture data delivery server by the terminal device, and for the contents identification to include a title of the moving picture data.

Moreover, according to the present invention, a terminal device in a comment delivery system includes a comment delivery server which delivers comments relating to music and the terminal device, the terminal device comprising: a music identification information transmitting section which transmits the music identification information for a piece of music targeted for playback to the comment delivery server; a comment information receiving section which receives from the comment delivery server comment information including comment contents and a comment attachment time which represents the time when the comment contents are attached by using an elapsed music playback time from the time when playback of the music started, the comment information being created in association with the music identification information for the piece of music; a comment information storage section which stores the comment information received by the comment information receiving section; and a display unit which displays the comment contents associated with a point in time indicated by the comment attachment time based on the comment information stored in the comment information storage section so as to be synchronized with the elapsed music playback time of the piece of music being played.

In the comment delivery system of the present invention, it is also possible for there to be provided: a music data storage section which associates music data for the piece of music with the music data identification information which identifies this piece of music; and a music playback section which reads and plays music data stored in the music data storage section, and for the display unit to display the comment contents which correspond to the elapsed music playback time of the music data being played by the music playback section.

Moreover, according to the present invention, a terminal device in a comment delivery system includes a comment delivery server which delivers comments relating to contents and the terminal device, the terminal device comprising: a contents identification information transmitting section which transmits the contents identification information for contents targeted for playback to the comment delivery server; a comment information receiving section which receives from the comment delivery server comment information including comment contents and a comment attachment time which represents the time when the comment contents are attached by using an elapsed contents playback time from the time when playback of the contents started, the comment information being created in association with the contents identification information for the contents; a comment information storage section which stores the comment information received by the comment information receiving section; and a display unit which displays the comment contents associated with a point in time indicated by the comment attachment time based on the comment information stored in the comment information storage section so as to be synchronized with the elapsed contents playback time of the contents being played.

Moreover, the present invention provides a comment delivery method in a comment delivery system including a comment delivery server which delivers comments relating to music and a terminal device, the comment delivery method in the comment delivery server including: receiving music identification information for a piece of music transmitted from the terminal device; reading comment information which corresponds to the received music identification information from a comment information storage section which stores, as the comment information, comment contents and a comment attachment time which represents the time when the comment contents are attached by using an elapsed music playback time from the time when playback of the piece of music started, the comment information being stored in association with music identification information for the piece of music; and delivering the read comment information to the terminal device which transmitted the music identification information, and the comment delivery method in the terminal device including: transmitting the music identification information for a piece of music targeted for playback to the comment delivery server; receiving the comment information transmitted from the comment delivery server and storing the comment information in a comment information storage section; and, based on the comment information stored in the comment information storage section, displaying the comment contents associated with a point in time indicated by the comment attachment time so as to be synchronized with the elapsed music playback time of the piece of music being played.

Moreover, the present invention provides a comment delivery method in a comment delivery system including a comment delivery server which delivers comments relating to contents and a terminal device, the comment delivery method in the comment delivery server including: receiving contents identification information for the contents transmitted from the terminal device; reading comment information which corresponds to the received contents identification information from a comment information storage section which stores, as the comment information, comment contents and a comment attachment time which represents the time when the comment contents are attached by using an elapsed contents playback time from the time when playback of the contents started, the comment information being stored in association with contents identification information for the contents; and delivering the read comment information to the terminal device which transmitted the contents identification information, and the comment delivery method in the terminal device including: transmitting the contents identification information for contents targeted for playback to the comment delivery server; receiving the comment information transmitted from the comment delivery server and storing the comment information in a comment information storage section; and, based on the comment information stored in the comment information storage section, displaying the comment contents associated with a point in time indicated by the comment attachment time so as to be synchronized with the elapsed contents playback time of the contents being played.

Moreover, the present invention provides a computer readable recording medium storing a program which causes to be executed on a computer of a terminal device of a comment delivery system having a comment delivery server which delivers comments relating to music, and the terminal device: a music identification information transmitting function in which the music identification information for a piece of music targeted for playback is transmitted to the comment delivery server; a comment information receiving function in which comment information including comment contents and a comment attachment time which represents the time when the comment contents are attached by using an elapsed music playback time from the time when playback of the music started is received from the comment delivery server, the comment information being created in association with the music identification information for the piece of music; a storage function in which the comment information received when the comment information receiving function was performed is stored in a comment information storage section; and a display function in which, based on the comment information stored in the comment information storage section, the comment contents associated with a point in time indicated by the comment attachment time are displayed so as to be synchronized with the elapsed music playback time of the piece of music being played.

Moreover, the present invention provides a computer readable recording medium storing a program which causes to be executed on a computer of a terminal device of a comment delivery system having a comment delivery server which delivers comments relating to contents, and the terminal device: a contents identification information transmitting function in which the contents identification information for contents targeted for playback is transmitted to the comment delivery server; a comment information receiving function in which comment information including comment contents and a comment attachment time which represents the time when the comment contents are attached by using an elapsed contents playback time from the time when playback of the contents started is received from the comment delivery server, the comment information being created in association with the music identification information for the contents; a storage function in which the comment information received when the comment information receiving function was performed is stored in a comment information storage section; and a display function in which, based on the comment information stored in the comment information storage section, the comment contents associated with a point in time indicated by the comment attachment time are displayed so as to be synchronized with the elapsed contents playback time of the contents being played.

### Effects of the Invention

As has been described above, according to the present invention, music identification information for a piece of music targeted for playback is transmitted to a comment delivery server, comment information which corresponds to this music identification information is received from the comment delivery server, and comment information to which has been assigned a comment attachment time which corresponds to the elapsed music playback time of the piece of music being played is displayed so that it conforms with the elapsed music playback time of the piece of music being played.

As a result, it is possible to enjoy music while utilizing both music and comments. Moreover, it is also possible to achieve communication between users via these comments.

Furthermore, according to the present invention, contents identification information for contents targeted for playback is transmitted to a comment delivery server, comment information which corresponds to this contents identification information is received from the comment delivery server, and comment information to which has been assigned a comment attachment time which corresponds to the elapsed contents playback time of the contents being played is displayed so that it conforms with the elapsed contents playback time of the contents being played.

As a result, it is possible to enjoy contents while utilizing both contents and comments. Moreover, it is also possible to achieve communication between users via these comments.

### BRIEF DESCRIPTION OF THE DRAWINGS

FIG. 1 is a conceptual view showing the structure of a comment delivery system according to a first embodiment of this invention.

FIG. 2 is a block diagram showing the structure of a comment delivery server according to the first embodiment of this invention.

FIG. 3 is a drawing showing an example of data which is stored in a comment information storage section in the first embodiment of this invention.

FIG. 4 is a schematic block diagram illustrating the structure of a terminal device in the first embodiment of this invention.

FIG. 5 is a drawing showing an example of information which is displayed on a display unit in the first embodiment of this invention.

FIG. 6 is a flowchart used to illustrate an operation of a comment delivery server in the first embodiment of this invention.

FIG. 7 is a flowchart used to illustrate an operation of a terminal device in the first embodiment of this invention.

FIG. 8 is a block diagram illustrating the structure of a terminal device in a second embodiment of this invention.

FIG. 9 is a drawing showing an example of information which is displayed on the terminal device in the second embodiment of this invention.

FIG. 10 is a flowchart used to illustrate an operation of a comment delivery server in the second embodiment of this invention.

FIG. 11 is a flowchart used to illustrate an operation of a terminal device in the second embodiment of this invention.

FIG. 12 is a conceptual view showing the structure of a comment delivery system in a third embodiment of this invention.

FIG. 13 is a schematic block diagram showing the structure of a comment delivery server in the third embodiment of this invention.

FIG. 14 is a drawing showing an example of data which is stored in a comment information storage section in the third embodiment of this invention.

FIG. 15 is a block diagram illustrating the structure of a terminal device in the third embodiment of this invention.

FIG. 16 is a drawing showing an example of information which is displayed on a display unit of a terminal device which does not have a comment registering function of this invention.

FIG. 17 is a block diagram illustrating the structure of a terminal device in a fourth embodiment of this invention.

FIG. 18 is a drawing showing an example of information which is displayed on a display device in the fourth embodiment of this invention.

### REFERENCE SYMBOLS

1 Music delivery server
1A Contents delivery device
2 Comment delivery server
3 Terminal device
4 Music list server
4A Contents identification information delivery server
21, 37, 313 Comment information storage section
24 Communication section
25 Comment information update control section
26 Comment information reading section
27 Comment information delivery section
31, 310 Music data storage section
31A, 310A Contents storage section
32, 317 Input section
33, 311 Music playback section
33A, 311A Contents playback section
34, 321 Audio output section
35 Music identification information transmitting section
35A Contents identification information transmitting section
36, 312 Comment information receiving section
38 Display unit
241 Comment information receiving section
242 Music identification information receiving section
242A Contents identification information receiving section
314 Display device
315 First display unit
316 Second display unit
318 Selection section
319 Reproduction control section
320 Transmitting section

### BEST MODE FOR CARRYING OUT THE INVENTION

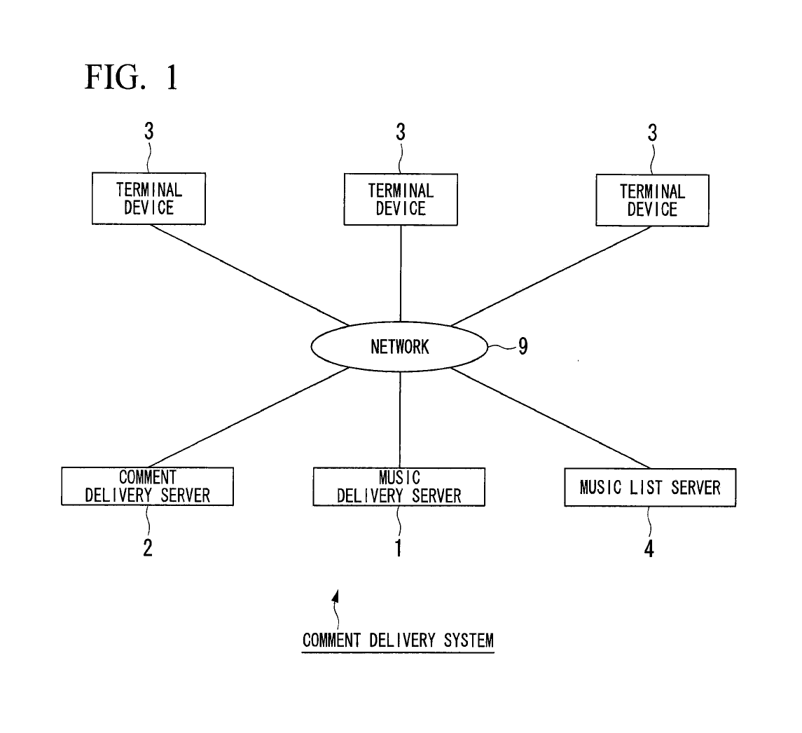

A comment delivery system according to a first embodiment of the present invention will now be described with reference made to the drawings. FIG. 1 is a conceptual view showing the structure of a comment delivery system according to the first embodiment of this invention. FIG. 1 shows a comment delivery system in which a music delivery server 1, a comment delivery server 2, terminal devices 3, and a music list server 4 are connected together via a network 9. The music delivery server 1 delivers music data in response to delivery requests from the terminal devices 3. This music data is delivered (i.e., downloaded), for example, as contents either free of charge or at a cost in response to the requests from the terminal devices 3.

The comment delivery server 2 receives comments relating to music from the terminal devices 3, and delivers the received comments to each of the terminal devices 3 which is playing that music.

The terminal devices 3 are able to be connected to the music delivery server 1, the comment delivery server 2, and the music list server 4 via the network 9, and play music which is output as audio. In addition, the terminal devices 3 receive comments delivered from the comment delivery server 2 and display these on a display screen.

The terminal devices 3 are also able to read music data from storage media such as music CDs (i.e., compact discs) and the like and store this data on their own storage devices. Alternatively, they are able to store music data which has been downloaded from the music delivery server 1 on their own storage devices, and play back this music data. Various devices may be used as the terminal devices 3 provided that they have a function of playing music and a function of displaying images, and examples thereof include PCs, portable music players, mobile telephones, PDA, and portable game devices and the like.

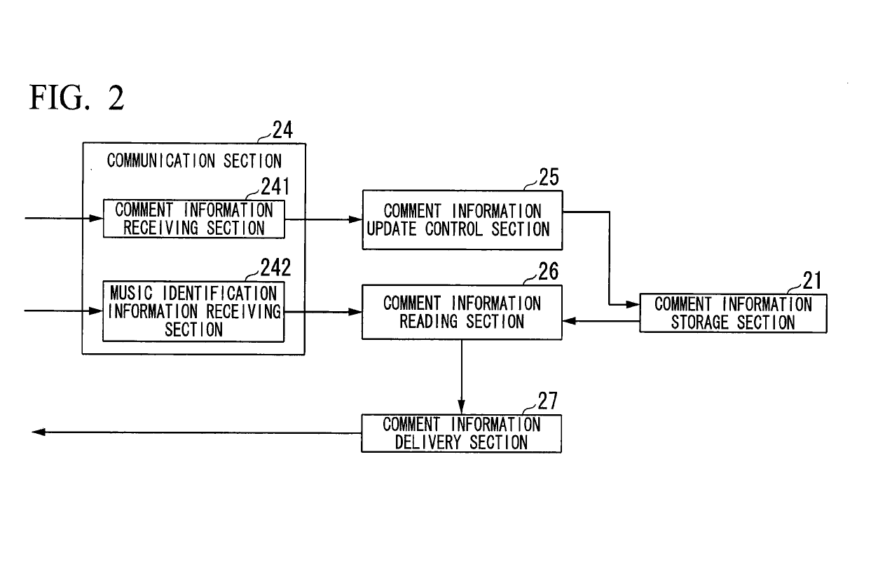

Next, the comment delivery server 2 and the terminal device 3 shown in FIG. 1 will be further described using FIG. 2.

FIG. 2 is a schematic block diagram showing the structure of the comment delivery server 2. In this drawing, a comment information storage section 21 assigns contents of comments and also a comment attachment time which represents the time when the comment contents were attached by using an elapsed music playback time from the time when playback of a piece of music started to music identification information, and stores these as comment information.

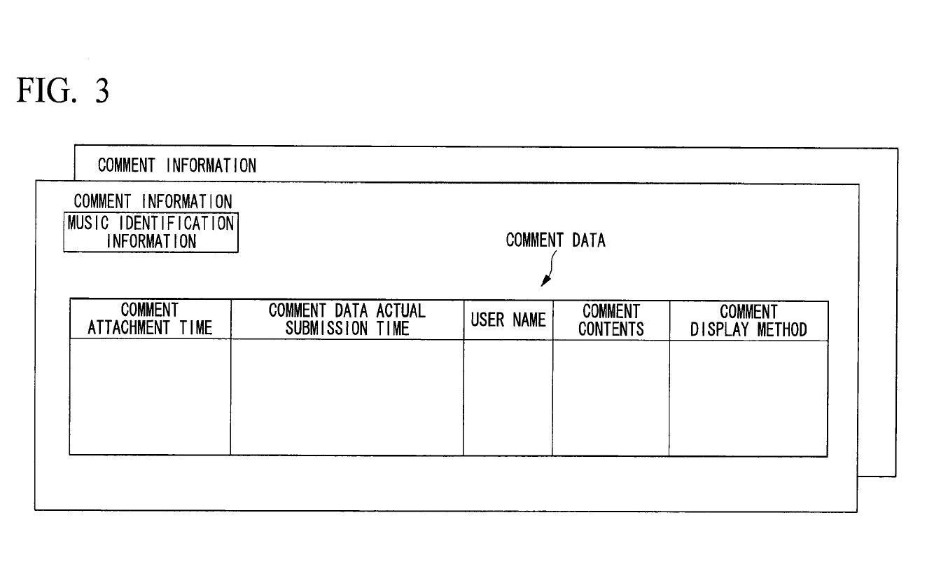

An example of data which is stored in this comment information storage section 21 is shown in FIG. 3. Comments on pieces of music are stored as comment information in the comment information storage section 21. Music identification information which identifies pieces of music is set in this comment information. As a result, it is possible to manage a plurality of items of comment information as threads for each piece of music. In addition to the comment attachment time and the comment contents, a plurality of items of comment data which relate to the comment information actual submission time which shows the actual time when a comment was attached (i.e. commented), the user name which is information identifying the user who attached the comment, and the comment display method which is information specifying the method used to display comments on the screen of the terminal device are included in the comment information. Moreover, when the piece of music which corresponds to the relevant music identification information is being played back, and comment data is received from a terminal device 3 which is accessing comments corresponding to this music identification information, the received comment data is additionally preserved.

Here, the music identification information is created by combining the title of a piece of music and the name of the artist performing the piece of music. Note that the music identification information may also be information other than the above described combination of the title of a piece of music and the name of the artist performing the piece of music provided that the information is able to identify a piece of music. For example, it is also possible to create waveform data by analyzing audio components contained in a piece of music, and to then analyze this waveform data so as to create identification information from the results of this analysis, and to then use this identification information as identification information specifying the music. Methods which use this type of waveform data include, for example, Music Id and TRM (acoustic fingerprinting technology).

Note that these comments may include moving pictures and static images (i.e., photos, illustrations, etc) in addition to text data.

In FIG. 2, the communication section 24 has a comment information receiving section 241 and a music identification information receiving section 242. In the communication section 24, the comment information receiving section 241 receives comment information transmitted from a terminal device 3. The music identification information receiving section 242 receives music identification information which is transmitted from a terminal device 3.

The comment information update control section 25 stores newly added comment information received from a terminal device 3 by the comment information receiving section 241 of the communication section 24 in the comment information storage section 21 in accordance with music identification information contained in this added comment information. Moreover, when the combination of music title and artist name in the music identification information is a new combination, the comment information update control section 25 associates this music identification information with comment information and makes a new registration in the comment information storage section 21.

The comment information reading section 26 reads from the comment information storage section 21 comment information which corresponds to the music identification information received by the music identification information receiving section 242.

The comment information delivery section 27 delivers comment information read by the comment information reading section 26 to the terminal device 3 which transmitted the music identification information.

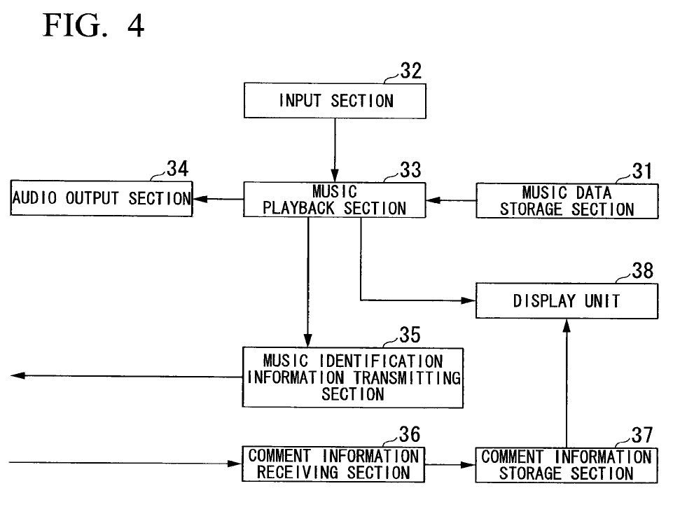

Next, a description will be given of a terminal device 3 using the drawings. FIG. 4 is a schematic block diagram illustrating the structure of a terminal device 3.

A music data storage section 31 associates music data which forms the data when a piece of music is being played with music identification information which identifies that piece of music and stores these.

The data format of the music data which is stored in the music data storage section 31 is not particularly restricted provided that the music data makes it possible to ascertain the music title, the artist name, and the playback position (i.e., the elapsed time since playback started). Data formats which can be used include, for example, MP3 (MPEG-1 Audio Layer-3), WMA (Windows Media (registered trademark) Audio), and AAC (Advance Audio Coding).

The input section 32 is an input device which receives input of commands for various operations from a user. When the terminal device 3 is, for example, a PC, this input device may be a mouse or keyboard or the like, while when the terminal device 3 is a portable music player, the input device may be the ten-key or various operating switches provided on the portable music player.

Based on playback commands input via the input section 32, the music playback section 33 reads music data from the music data storage section 31 for a piece of music whose playback has been commanded, and plays the commanded piece of music.

The audio output section 34 outputs audio data which is being played by the music playback section 33 as audio. This audio output section 34 is formed by, for example, speakers or headphones or the like.

The music identification information transmitting section 35 transmits music identification information for a piece of music targeted for playback to the comment delivery server 2. The transmitting of this music identification information is achieved by music identification information being output from the music playback section 33 to the music identification information transmitting section 35 in response to a playback command being input from the input section 32 to the music playback section 33. The comment information receiving section 36 receives comment information transmitted from the comment delivery server 2. The comment information storage section 37 stores comment information received by the comment information receiving section 36.

A display unit 38 displays comments which have been associated with a comment attachment time which corresponds to the elapsed music playback time for a piece of music being played from among the comment information received by the comment information receiving section 36 and stored in the comment information storage section 37. When the terminal device 3 is a PC, this display unit 38 is a liquid crystal display device or CRT (Cathode Ray Tube) or the like, while when the terminal device 3 is a portable music player, this display unit 38 is a liquid crystal display device or the like.

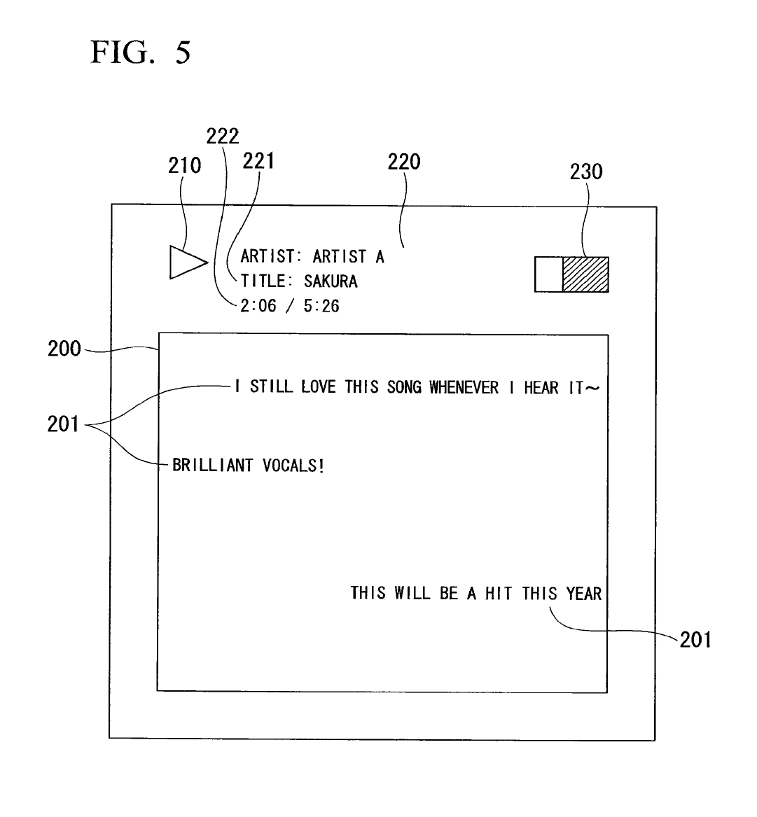

The information displayed on this display unit 38 will now be described further. FIG. 5 shows an example of information which is displayed on the display unit 38 when the terminal device 3 is a portable music player.

A display box 200 is an area where comments stored in the comment information storage section 37 are displayed. Here, as is shown by the symbol 201, a plurality of comments are displayed. A mark showing the current state of the music player is displayed in a status display box 210. This status may be, for example, playing, fast forwarding, rewinding, pausing, or the like, and, here, a mark showing playing is displayed.

A display unit 220 is where the name of the artist performing the piece of music being played is displayed. A display box 221 is where the title of the piece of music being played is displayed. A display box 222 is where the total playback time of the piece of music and the current elapsed playback time of the piece of music being played are displayed.

A display box 230 is where the remaining battery life of the portable music player is displayed.

Next, an operation of the above described comment delivery system will be described. Here, descriptions will be given sequentially of operations of the comment delivery server 2 and the terminal device 3.

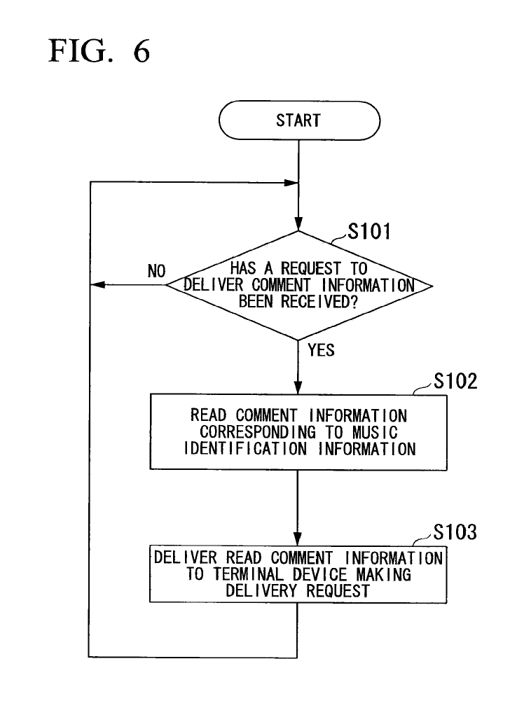

Firstly, a description will be given using the flowchart shown in FIG. 6 of an operation of the comment delivery server 2 when the terminal device 3 is a portable music player.

The music identification information receiving section 242 of the comment delivery server 2 detects whether or not a comment information delivery request has been received from a terminal device 3 (step S101). When no request to deliver comment information has been received (step S101—NO), then this detection as to whether or not a comment information delivery request has been received is made at fixed time intervals.

If, on the other hand, a comment information delivery request has been received (step S101—YES), the music identification information receiving section 242 outputs to the comment information reading section 26 music identification information which is formed by a combination of the music title and artist name which are included in the delivery request. The comment information reading section 26 reads from the comment information storage section 21 comment information which corresponds to the music identification information output from the music identification information receiving section 242 (step S102), and commands the comment information delivery section 27 to make a delivery. The comment information delivery section 27 delivers the comment information read by the comment information reading section 26 to the terminal device 3 which made the delivery request (step S103). Here, each individual item of comment information which corresponds to the music identification information is transmitted as a collected bundle.

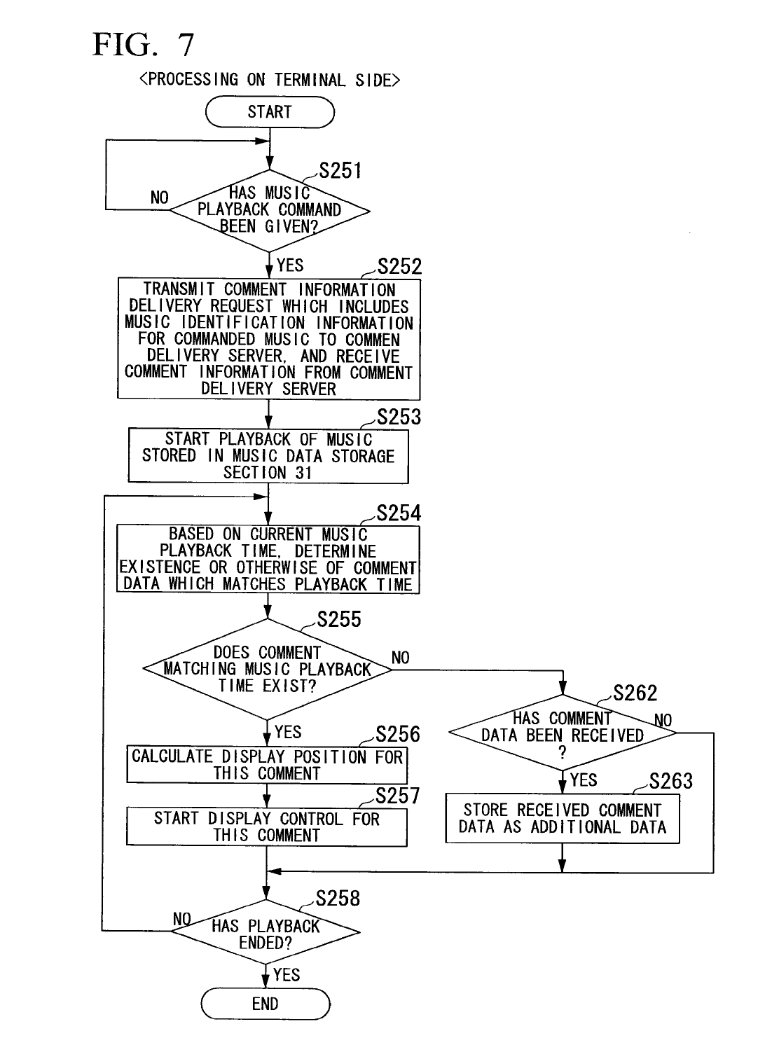

Next, a description will be given using the drawings of an operation of a terminal device 3. FIG. 7 is a flowchart used to illustrate an operation of a terminal device 3 when the terminal device 3 is a portable music player.

When an input is received from the input section 32 that a user has selected music for playback via a menu screen, and when a further command to play the music has been input (step S251—YES), the music playback section 33 of a terminal device 3 transmits by means of the music identification information transmitting section 35 to the comment delivery server 2 the comment information delivery request which includes music identification information for the commanded music. If the comment information delivered from the comment delivery server 2 has been received by the comment information receiving section 36 (step S252), the terminal device 3 stores the comment information in the comment information storage section 37.

When the comment information has been received and stored in the comment information storage section 37, the music playback section 33 reads the music data stored in the music data storage section 31, plays the read music data, and outputs audio using the audio output section 34 (step S253). When playback of the music starts, based on the current elapsed music playback time, the display unit 38 determines by referring to the comment information storage section 37 whether or not comment data exists for which a comment attachment time which matches the elapsed music playback time has been set (step S254). If comment data for which a comment attachment time which matches the elapsed music playback time does exist (step S255—YES), the display unit 38 calculates a display position for this comment data (step S256). The display unit 38 then controls the display of comments on the display screen in accordance with the calculated display position (step S257).

Meanwhile, the music playback section 33 determines whether or not playback has ended (step S258), and if playback has ended then processing is ended. If playback has not ended, the routine moves to step S254.

If, however, in step S255, there are no comments to display (step S255—NO), the comment information receiving section 36 detects whether or not comment data has been received (step S262). If comment data has been received (step S262—YES), the comment information receiving section 36 stores the received comment data as additional data in the comment information storage section 37 (step S263), and the routine moves to step S258.

If, however, in step S262, comment data has not been received (step S262—NO), the routine moves to step S258.

As a result of this type of processing being performed, various types of comments such as those shown in FIG. 5 are displayed in sequence on the display screen of the terminal device 3 so as to be synchronized with the elapsed music playback time. Text data, moving pictures, photos, and illustrations and the like which have been registered as comments are displayed on this screen. As a result, the user who is listening to music can be referred to comments made about that music. Moreover, if the comments are information which have some relationship to that music, then information relating to the music can be referred to the user so as to conform to the playback progress of that music.

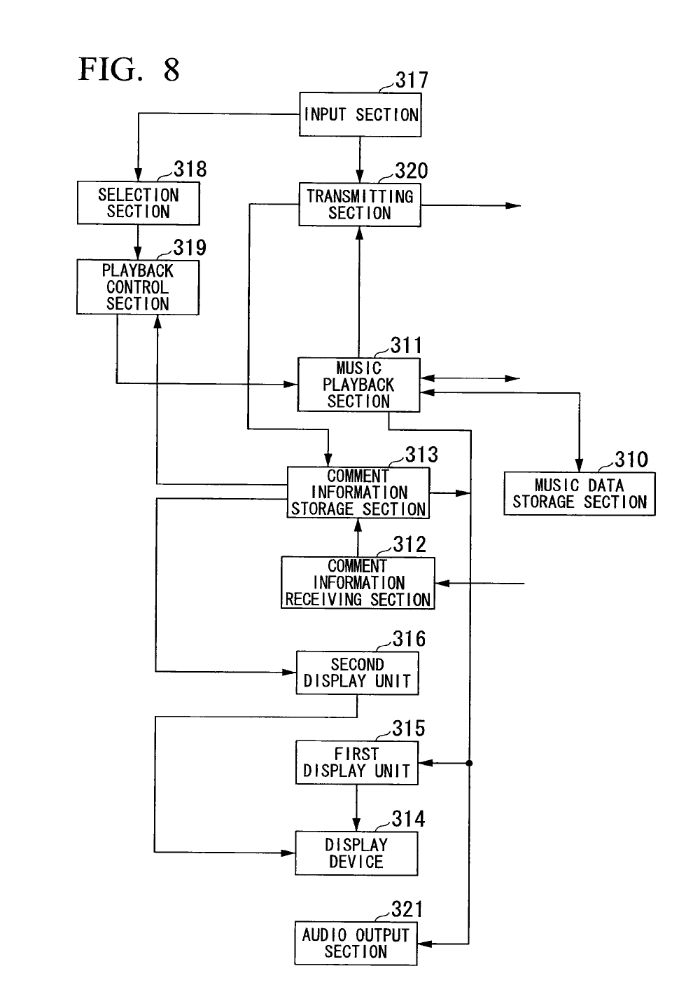

Next, a second embodiment will be described. In this embodiment, a description is given of a case in which a terminal device 3 has the comment registering function of a PC or the like. FIG. 8 is a schematic block diagram illustrating the structure of a terminal device 3 in the second embodiment.

In this drawing, a music data storage section 310 associates music data which forms the data for playing music with music identification information identifying the relevant music, and stores these. The information which is stored in this music data storage section 310 is the same as that stored in the above described music data storage section 31.

A music playback section 311 reads music data stored in the music data storage section 310 and outputs audio by means of an audio output section 321. When there is no data for the music title or artist name in the music data, the music playback section 311 accesses the music list server 4 when storing music in the music data storage section 310, and retrieves and receives information about the music title and artist name which correspond to the music, and associates these with the music data, and then stores these in the music data storage section 310. The comment information receiving section 312 receives from the comment delivery server 2 comment information which has been input for the piece of music being played back. The comment information storage section 313 stores comment information received by the comment information receiving section 312.

The display unit 314 is a liquid crystal display device or CRT (Cathode Ray Tube) or the like and displays various types of information. A first display unit 315 acquires an elapsed music playback time for the piece of music being played from the music playback section 311. In addition to this, the first display unit 315 reads from the comment information storage section 313 comments to which has been assigned a comment attachment time which corresponds to the acquired elapsed music playback time for the piece of music from among comment information stored in the comment information storage section 313, and displays comments in the read comment information using the display device 314.

A second display unit 316 displays a list of comments on the display device 314 based on comment data stored in the comment information storage section 313. Here, the display is shown in the sequence of the information of the actual comment submission time included in the comment data.

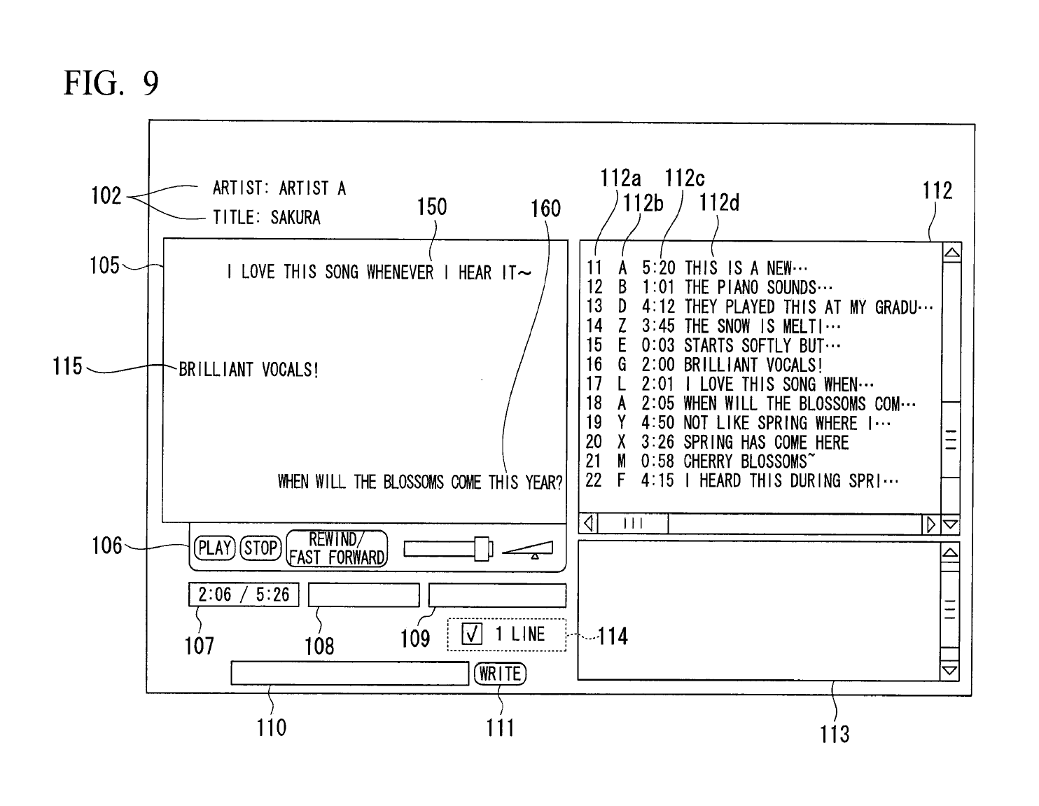

The information displayed on this display device 314 will now be further described. FIG. 9 shows an example of information displayed on the display device 314. A display unit 102 is where the name of the artist performing the piece of music being played back and the title of the piece of music being played back are displayed. A display box 105 is an area where comments are displayed by the first display unit 315.

A play button, a stop button, a rewind button, a fast forward button, a volume adjustment button, a playback state display box which shows which portion of the overall music piece is currently being played and the like are displayed on an operating panel 106. By positioning a cursor over any of these buttons using a mouse and then clicking the mouse, input is received for an operation corresponding to that button. The length of playback time of the total piece of music and the current elapsed playback time of the piece of music being played are displayed in a display box 107. The name of a user currently making a comment about a piece of music is input into an input box 108 via an input section 317. Here, a check box is provided adjacent to the input box 108 and, by checking or not checking this check box, a user can select whether to input or not input their email address. Namely, when this check box has been checked, the input box 108 is divided into two boxes one of which receives the input of the user name, and the other of which receives the input of the user's email address. Information specifying how a comment is to be displayed is input into an input box 109. Information specifying how a comment is to be displayed can be set, for example, for the position at which the comment is displayed on a moving picture, and also for the font, the character size, the start position, end position, and movement direction of a moving comment, and the like. Note that, here, the method used to display a comment can also be decided in advance so that the user does not have to make any input themselves.

Comments are input into an input box 110 by a user via the input section 317. When a button 111 is clicked, the comments input into the comment box 110, as well as the name of the user which has been input into the input box 108 and information about how the comment is to be displayed which has been input into the input box 109 are transmitted to the comment delivery server 2. A display box 112 is an area where a list of comments is displayed by the second display unit 316. In this list of comments are displayed numbers showing the comment sequence which is attached to the comments (112a), the names of the users who input the comments (112b), comment attachment times showing when the comments were written (112c), and the first portion of each comment (112d) in accordance with the sequence of the information for the actual time when they were submitted. An input box such as a check box or the like for specifying whether or not to display this display box 112 on the screen is provided adjacent to the display box 112 so that it is possible to either display or hide the display box 112 in accordance with the command to display or not display which is input into this input box. Moreover, it is also possible for the number of the portion of the comments which are displayed on the display box 112 to be altered in accordance with a command from the user. A display box 113 displays details of those comments from among the list of comments displayed in the display box 112 over which the cursor has been placed by the user. Comment details may include the entire comment text, and the name and email address and the like of the user who made the comment.

A check box 114 is used to specify that one line of each comment input into the comment box 110 is displayed, and does so when a check mark is input therein. For example, if a check mark is input into the check box 114 and the inputting of a comment has been completed, and the inputting is then completed, for example, by pressing the enter key or the like, at the moment that the enter key is pressed, the “write” button is taken as having been clicked, and the comment is transmitted to the comment delivery server 2. As a result, it is possible to easily and quickly input a comment.

Next, returning to FIG. 8, the input section 317 is an input device such as a mouse or keyboard and receives inputs of various types of information from a user. A selection section 318 receives inputs of selections of comments which are input via the input section 317 from the list of comments displayed by the second display unit 316. A playback control section 319 reads from the comment information storage section 313 comment data for comments selected by the selection section 318, and causes music to be played by the music playback section 311 from the elapsed music playback time which corresponds to the comment attachment time in the read comment data.

A transmitting section 320 receives from the input section 317 data input for comment contents for music being played by the music playback section 311. When comment contents are input, the transmitting section 320 transmits to the comment delivery server 2 the elapsed music playback time at the point when the comment contents were input as the comment attachment time together with the comment contents, and stores the delivered comment information in the comment information storage section 313. The transmitting section 320 also has a function of transmitting various types of information to the comment delivery server 2 and the music delivery server 1 in accordance with a command input from the input section 317.

Next, an operation of the comment delivery system in the above described second embodiment will be described. Here, descriptions will be given sequentially of operations of the comment delivery server 2 and the terminal device 3.

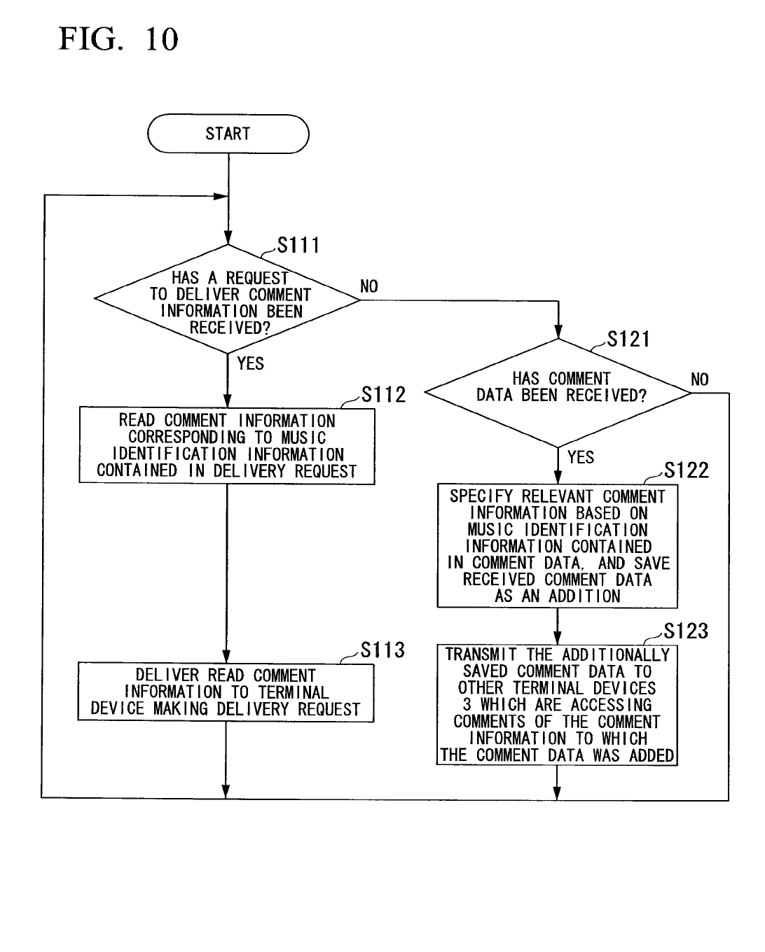

Firstly, a description will be given using the flowchart shown in FIG. 10 of an operation of the comment delivery server 2.

The communication section 24 of the comment delivery server 2 detects whether or not a comment information delivery request has been received from a terminal device 3 (step S111). When a comment information delivery request has been received (step S111—YES), in the same way as in steps S102 through S104 of the first embodiment, comment information which corresponds to the music identification information contained in the delivery request is read (step S112), and is transmitted to the terminal device 3 (step S113).

In contrast, when there is no comment information delivery request, and comment data transmitted from the terminal device 3 is received by the comment information receiving section 241 (step S121—YES), the comment information update control section 25 specifies the relevant comment information based on the music identification information contained in the comment data, and saves the received comment data in the comment information storage section 21 as additional data (step S122). The comment information delivery section 27 delivers the additionally saved comment data to other terminal devices 3 which are accessing the comments in the comment information to which this comment data was added (step S123). In contrast, when there is no comment information delivery request (step S111—NO), and comment data transmitted from the terminal device 3 has not been received (step S121—NO), the routine moves to step 5111.

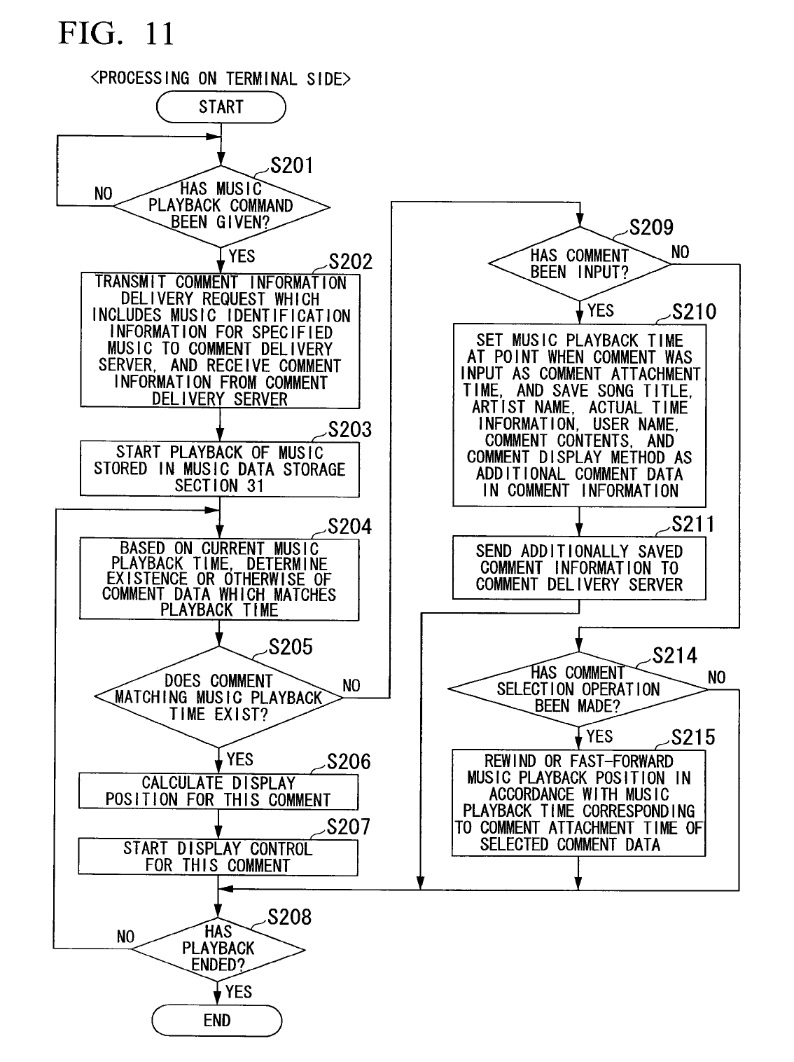

Next, a description will be given using FIG. 11 of an operation of a terminal device 3. FIG. 11 is a flowchart used to illustrate an operation of a terminal device 3.

When a command is input from a user for music playback (step S201—YES), the input section 317 of a terminal device 3 transmits to the comment delivery server 2 the comment information delivery request which includes music identification information for the commanded music, and then receives the comment information (step S202), and stores the comment information in the comment information storage section 313.

When the comment information has been received and stored in the comment information storage section 313, in the same way as in steps 5253 through 5258 of the first embodiment, the terminal device 3 plays the music (step S203), and determines whether or not comment data exists which matches the elapsed music playback time (step S204). If matching comment information does exist (step S205—YES), the terminal device 3 calculates a display position for this comment data (step S206). The terminal device 3 then controls the display of comments on the display screen in accordance with this display position (step S207). Next, the music playback section 311 determines whether or not playback has ended (step S208), and if playback has ended (step S208—YES), then processing is ended. If playback has not ended (step S205—NO), the routine moves to step S204.

If, however, in step S205, there are no comments to display (step S205—NO), the transmitting section 320 detects whether or not a comment has been input from the input section 317 (step S209). The input of this comment may be made during playback or may be made while the music has been temporarily paused. If a comment has been input (step S209—YES), then at the point in time when the comment was input (for example, at the point in time when the [write] button (111) was clicked), or at the point in time when the music was temporarily paused, the elapsed playback time (i.e., the elapsed music playback time) indicated by the software player which is playing the music is read. Next, the transmitting section 320 sets that elapsed music playback time as the comment attachment time, and associates the music title and artist name of the music being played together with information for the actual current time (i.e., information about the current time), the user name of the user of the terminal device 3, the content of the input comment, and the comment display method, and saves these as additional comment information in the comment list of the comment information storage section 313 (step S210). The transmitting section 320 then transmits the additionally saved comment information to the comment delivery server 2 (step S211), and the routine moves to step S208.

In step S209, if there is no comment input (step S209—NO), the selection section 318 of the terminal device 3 detects whether or not an input of a comment selection operation has been made from the input section 317 (step S214). If a comment selection operation has been input (step S214—YES), the selection section 318 outputs the comment contents of the selected comment data to the playback control section 319. The playback control section 319 receives this output, and reads the comment attachment time which was associated with the selected comment data and then stored by referring to the comment information storage section 313. Next, in accordance with the elapsed music playback time which corresponds to the read comment attachment time, the playback control section 319 rewinds or fast-forwards the music playback position so that playback starts from the elapsed music playback time which matches the comment attachment time which was associated with the comment data and then stored (step S215). In addition, the comment contents for that comment attachment time are displayed, and the routine then moves to step S208. If, however, there is no comment operation (step S214—NO), the routine moves to step S208.

Next, a description will be given using FIG. 9 of a case in which a comment is displayed on a screen. Here, when a piece of music called ‘Sakura’ by ‘Artist A’ is played, comment information for that piece of music is displayed in sequence in accordance with the elapsed music playback time, for example, within the area of the display box 105 shown in FIG. 9. In FIG. 9, a screen is displayed for when the elapsed music playback time is 2 minutes and 06 seconds. Here, a comment “Brilliant vocals” from User G having a comment attachment time of 2 minutes 00 seconds is displayed moving from the right side to the left side of the screen (115). As the playing of the piece of music progresses and the elapsed moving picture playback time reaches 2 minutes 01 seconds, the comment “I love this song whenever I hear it˜” is displayed (150). Next, the comment “When will the blossoms come this year?” having a comment attachment time of 2 minutes 05 seconds is displayed in a position at the bottom of the screen (160). In this manner, the comments are displayed in sequence.

An operation of only one terminal device 3 has been observed in the above description, however, by playing music and registering comments, and, when this music is played the next time, by accessing the comment delivery server 2 and playing back the newly acquired comment information, users who are watching a music piece having the same title and artist name are able to exchange comments with each other.

Moreover, in the above described embodiment, it is also possible for a user who has made a comment to delete that comment, and for users other than the user making a comment to also delete that comment. Here, the deleting of a comment can be performed, for example, by stopping it from being displayed on screen in accordance with a comment delete command input via a terminal device 3 from a user having the right to delete that particular comment. Moreover, even if users do not directly have the right to delete a comment, it is also possible for a particular comment to be displayed semi-transparently or to be stopped from being displayed if the number of comment delete requests from users without deleting rights reaches a certain level. Here, this command to delete a comment may be received by the comment delivery server 2 and the comment subsequently deleted from the comment information storage section 21, or the display method for a comment for which a delete command has been input may be set to [No display]. Alternatively, it is also possible for a comment to be set to [Semi transparent] or [Transparent] in accordance with the number of delete commands

As a result of the above, it is possible for a comment to be displayed after the opinion of the controller of the thread or of other users has been considered as to whether or not that comment is suitable for a particular piece of music. Moreover, even if a user does not have sufficient rights to be able to delete a particular comment simply because they wish to, it is also possible for that comment to be deleted or displayed differently from other comments, for example, semi-transparently in accordance with the number of users. As a result, it is possible for comments to be written and deleted by a plurality of users, so that the entertainment level among users is enhanced.

Moreover, a description has been given above of when the comment display method is [normal], [semitransparent], or [transparent], however, it is sufficient if comments targeted for deleting are displayed differently from normal comments. For example, it is also possible to create multiple levels of semitransparency, or to alter the color of comments, or alter the character size, character font, or color gradation, or to show the characters as white on a colored background or the like.

Moreover, it is also possible to receive an input request from a user who has rights to delete a comment to retract a comment deletion, and for the deleted comment to be displayed again in accordance with this command.

Moreover, it is also possible for a log which goes back for a fixed period from a particular point in time to be extracted from a log of comment information stored in the comment information storage section 21 of the comment delivery server 2, and for this to be stored as master comment information. Newly registered comment information may then be stored sequentially in the comment information storage section 21 as normal comment information, and when a transmission request for comment information is made from a terminal device 3, this master comment information and the normal comment information can be delivered to the terminal device 3. In the terminal device 3, the master comment information is then displayed on screen as a first layer, and the normal comments can then be superimposed on the screen on top of this layer. Here, a system can be employed in which the master comment information cannot be deleted by anyone other than the controller or specific users or the like, while normal comment information can be deleted. As a result, previous memorable comments can be kept active, while enabling users to make further additions to those comments.

Note also that it is also possible to install plug-ins in terminal devices which have a function of playing music which provide them with the functions of the terminal devices 3 which they currently lack, and to thereby enable them to perform the same functions as those of the above described terminal devices 3.

Next, a third embodiment will be described.

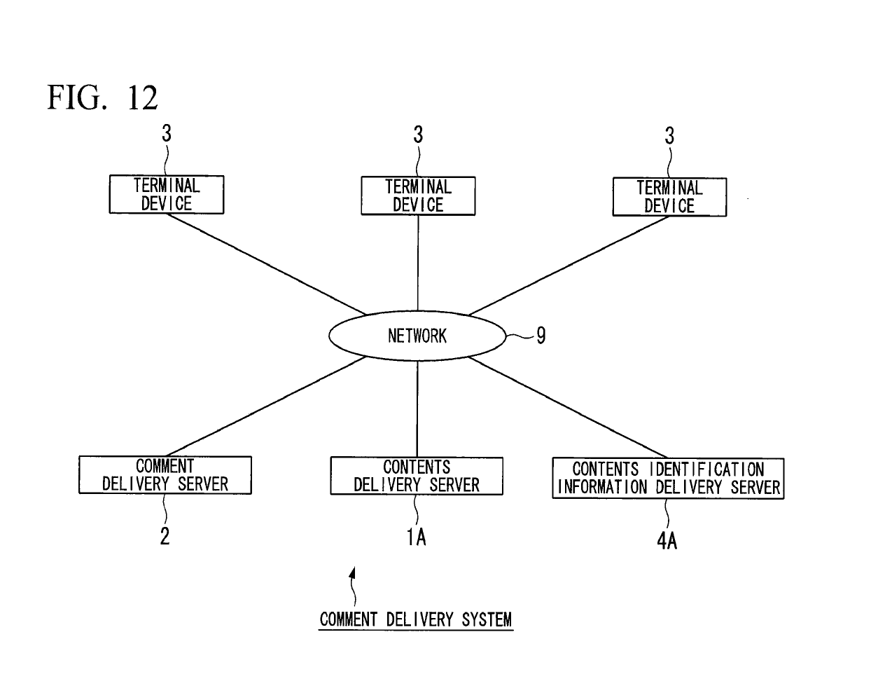

FIG. 12 is a conceptual view showing the structure of a comment delivery system according to the third embodiment.

In FIG. 12, components which correspond to those in FIG. 1 are allocated the same symbols, and a description thereof is omitted.

A contents delivery device 1A has a function of delivering contents via a network 9. This contents delivery device 1A is, for example, a broadcast device of a broadcasting station which delivers contents in the form of television or radio programs, and delivers these via the network 9. In this case, a cable system such as the Internet or a LAN (local area network) or the like is used for the network 9, and it is also possible for a wireless system such as ground waves or the like to be used. Here, the contents may be information whose output content change in a time series, namely, contents whose output content change with the passage of time. Examples of such output content include images, video, audio, and the like. The format in which these contents are saved may be image data and audio data, or may be a program which, when executed, causes images, video, or audio to be output. Specifically, these contents may be movies, news, dramas, variety programs, music programs, or the like. Examples of the contents include moving picture data in the case of a television program, and audio data in the case of a radio program.

A contents identification information delivery server 4A delivers contents identification information which identifies contents. This contents identification information is delivered, for example, as an EPG (Electronic Program Guide), and by referring to this EPG, in a terminal device 3, it is possible to specify the contents identification information for the delivered contents. Here, the contents identification information are set for each contents, and, for example, different contents identification information may be set for each program.

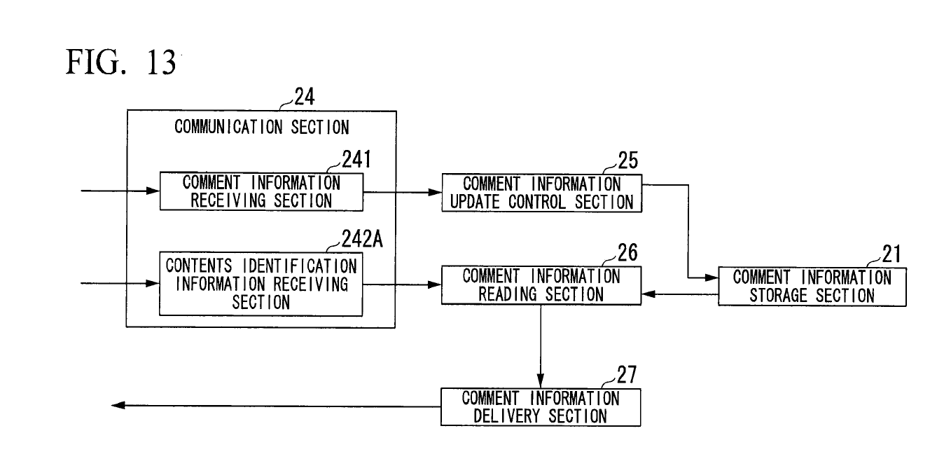

FIG. 13 is a schematic block diagram showing the structure of the comment delivery server 2 in the third embodiment. In FIG. 13, components which correspond to those shown in FIG. 2 are given the same symbols and a description thereof is omitted.

A contents identification information receiving section 242A receives content identification information transmitted from a terminal device 3. Comment information which corresponds to contents identification information received by the contents identification information receiving section 242A is read by the comment information reading section 26.

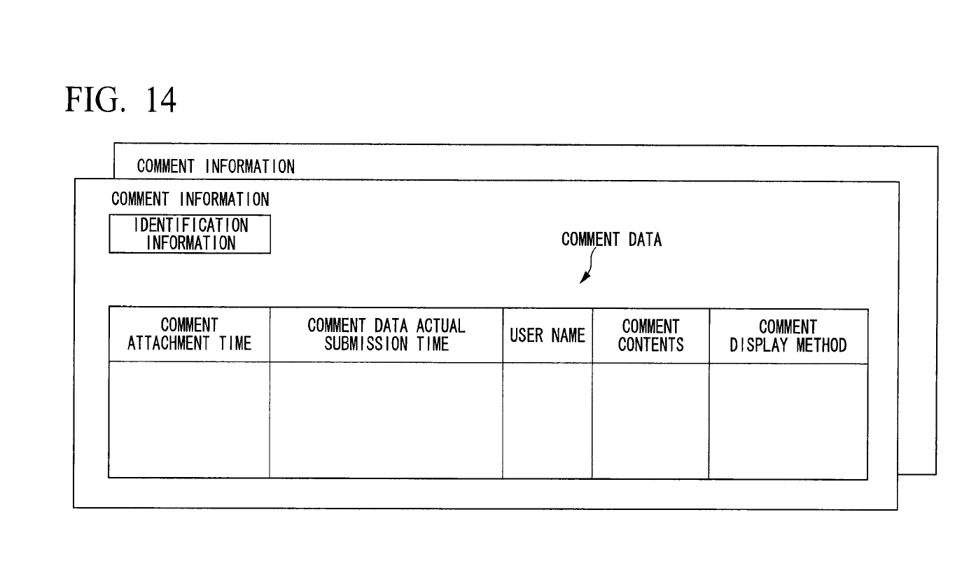

In the structure shown in FIG. 2, the comment information storage section 21 stores comments for pieces of music as comment information, however, in this embodiment, as is shown in FIG. 14, comments on contents are stored as comment information. The data structure of the comment information is the same as that shown in FIG. 3, therefore, a description thereof is omitted.

Next, a description will be given of a terminal device 3.

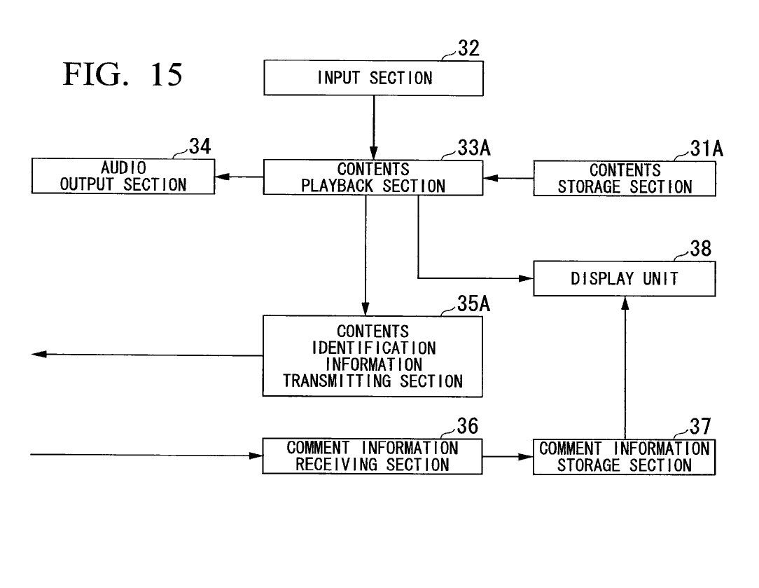

FIG. 15 is a schematic block diagram illustrating the structure of a terminal device 3 in the third embodiment. In FIG. 3, components which correspond to those in FIG. 4 are given the same symbols, and a description thereof is omitted.

A contents storage section 31 A associates contents targeted for playback with contents identification information which identify the relevant contents, and stores these. These contents are the contents received by the terminal device 3 from the contents delivery device 1A and then stored, and provided that they contain information which makes it possible to identify the contents (for example, contents identifying information obtained from an EPG), and make it possible to ascertain the playback position (i.e., the elapsed time after playback starts), then the data format of these contents is not particularly restricted.

A contents playback section 33A reads from the contents storage section 31A contents whose playback has been commanded and plays these based on a playback command input from the input section 32.

A contents identification information transmitting section 35A transmits to the comment delivery server 2 contents identification information for the contents targeted for playback. The transmitting of this contents identification information is performed by contents identification information being output from the contents playback section 33A to the contents identification information transmitting section 35A when a playback command is input from the input section 32 to the contents playback section 33A.

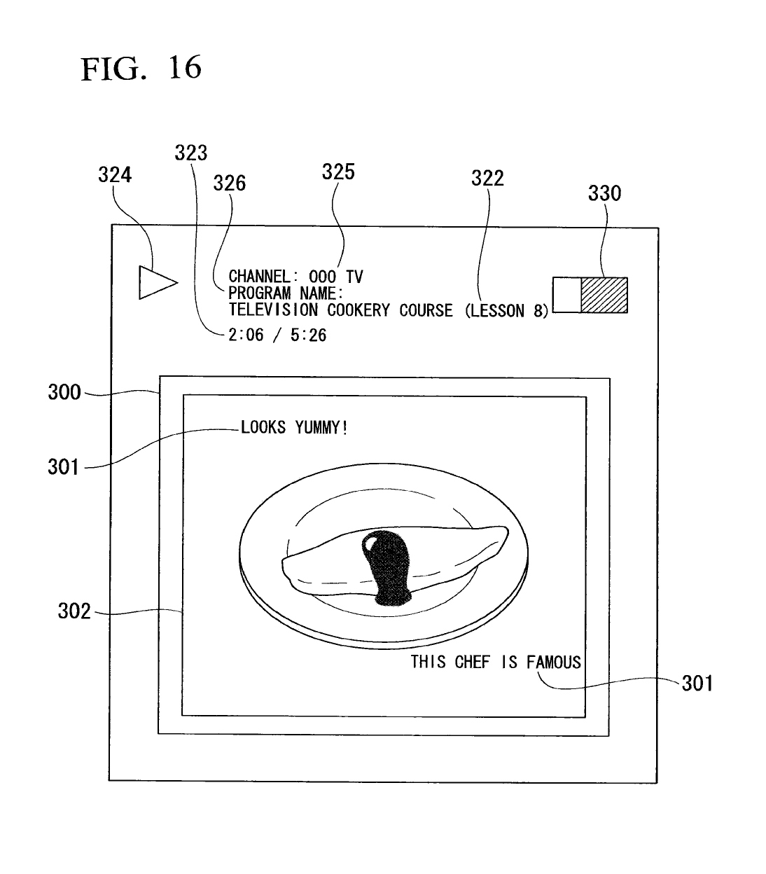

Here, a description will be given of information displayed on the display unit 38. FIG. 16 shows an example of information displayed on the display unit 38 of a terminal device 3 which does not have a comment registering function. Here, a case is illustrated in which a recorded (and stored in the contents storage section 31A) television program is played back on a portable player.

In this drawing, a display box 300 is where comments made about the contents are displayed. Here, a plurality of comments indicated by the symbol 301 are displayed. A display box 302 is where the contents being played back are displayed. Here, the size of the display box 300 is set larger than that of the display box 302, and comments and the like which are displayed in overlay are limited to areas on the outer side of the moving picture display screen. The actual comments themselves are not included in the moving pictures, and it can be seen that they have been written for the moving pictures by a user.

A status box 324 is where a mark showing the current state of the terminal device 3 is displayed. This status may be, for example, playing back, fast forwarding, rewinding, pausing, or the like, and when a broadcast program is being received and output, a mark showing that reception is currently occurring is displayed. Note that, here, a mark showing that playback is currently occurring is displayed.

A display box 325 is where the name of the channel on which the playback contents were broadcast is displayed. A display box 326 is where the name of the program being played back is displayed. Here, even if the program is the same, if the broadcast date is different, then a different contents identification number is attached. In this case, in addition to the program name, the number of broadcasts is displayed in a display box 322. Instead of this number of broadcasts, it is also possible to display the date of the broadcast. A display box 323 is where the total playback time of the contents being played back and the current elapsed playback time of the contents being played back are displayed.

A display box 330 is where the remaining battery life is displayed when the terminal device 3 is a portable music player or the like which operates on batteries.

Next, an operation of the above described third embodiment will be described. In this third embodiment, the operation is fundamentally the same as that in the first embodiment. Namely, the comment delivery server 2 detects whether or not a comment information delivery request has been received from a terminal device 3. If a comment delivery request has not been received, then this detection as to whether or not a comment information delivery request has been received is made at fixed time intervals. If, on the other hand, a comment information delivery request has been received, comment information corresponding to the contents identification information contained in the delivery request is read from the comment information storage section 21, and is delivered to the terminal device 3 which made the delivery request.

Based on a command from a user, the terminal device 3 receives the contents delivered from the contents delivery device 1A and stores it in the contents storage section 31A. When contents targeted for playback are specified and a playback command is input, the contents identification information thereof is transmitted to the comment delivery server 2. The comment information is then received and stored in the comment information storage section 37.

The terminal device 3 plays back the contents and displays images on the display unit 38. In addition, it outputs audio using the audio output section 34. Next, based on the elapsed contents playback time, content data for which a comment attachment time which matches the elapsed contents playback time has been set is displayed on the display unit 38 in accordance with the display position thereof When comment information is additionally received from the comment delivery server 2, the terminal device 3 stores this additionally received comment in the comment information storage section 37, and displays it in accordance with the elapsed playback time.

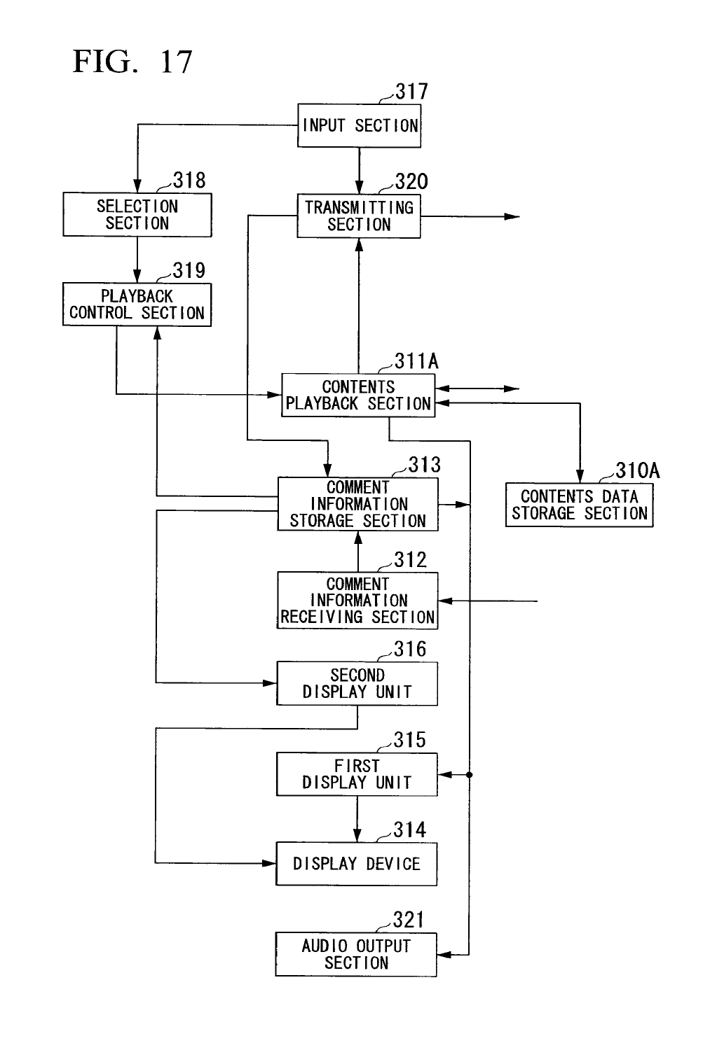

Next, a fourth embodiment will be described. In this embodiment, a description is given of a case in which a terminal device 3 has the comment registering function of a PC or the like. FIG. 17 is a schematic block diagram illustrating the structure of a terminal device 3 in the fourth embodiment.

In this drawing, portions corresponding to those in FIG. 8 are given the same symbols and a description thereof is omitted.

A contents storage section 310A stores contents. The information which is stored in this contents storage section 310A is the same as the information stored in the contents storage section 31A shown in FIG. 15. A contents playback section 311A reads contents stored in the contents storage section 310A, and outputs audio using the audio output section 321. In addition, when images are contained in the contents, the contents playback section 311A displays these images using the display unit 314.

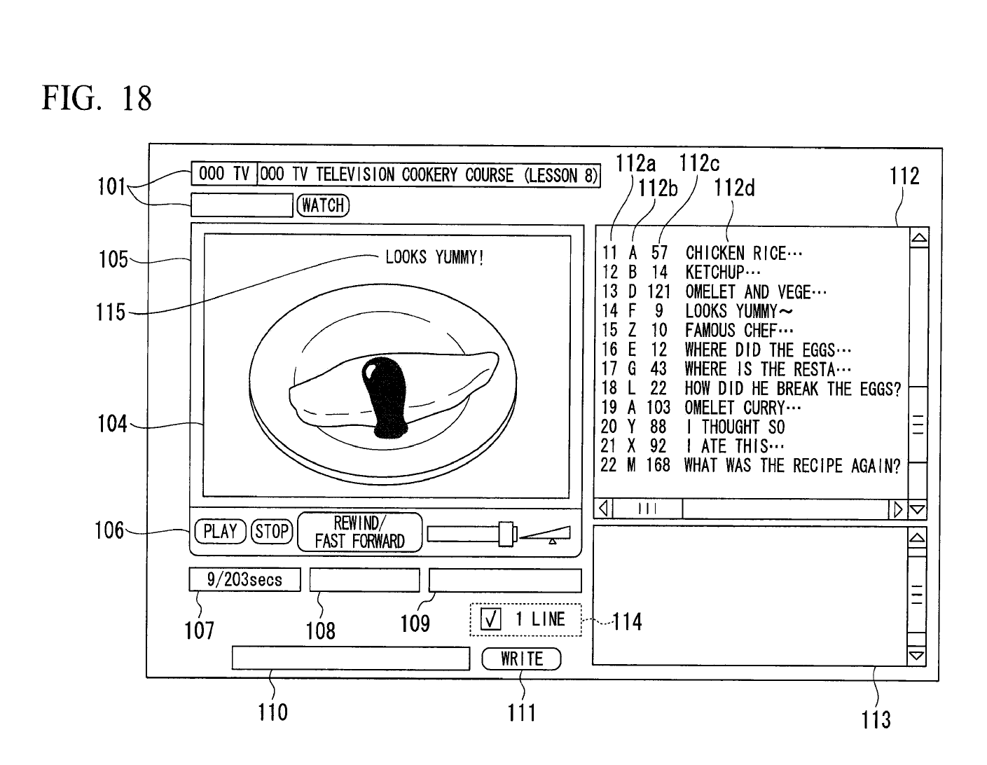

FIG. 18 shows an example of information displayed on the display unit 314 of the fourth embodiment. In FIG. 18, components which correspond to those in FIG. 9 are given the same symbols, and a description thereof is omitted.

In FIG. 18, a display box 101 is where the channel and program name which correspond to the contents currently being played back are displayed. Here, when a single program is divided into a plurality of files, then the file names are also displayed. In the display box 104 are displayed the moving pictures which are displayed by the first display unit 315. Note that when images are not contained in the contents (for example, as with a radio program), then a default image or an image specified by a user is displayed in the display box 104.

Next, an operation of the comment delivery system of the above described fourth embodiment will be described. Here, the operation is fundamentally the same as that in the second embodiment. Users read comments which are displayed in the display box 105 while watching contents, and are also able to view images displayed in the display box 104 and, if necessary, supply their own comments by inputting them using the input section 317.

Note that in the above described embodiment a case is described in which the contents are a program, however, even when the contents are not delivered as a program, the above described embodiment can also be applied. For example, it is also possible to use a server which streams contents or delivers contents as VOD (Video On Demand) as the contents delivery device 1A, and to deliver contents such as moving images or the like to the terminal devices 3.

In this case, when receiving such contents, if contents identification information cannot be obtained from the contents delivery server 2, then, when storing the contents in the contents delivery storage section 310A, the contents playback section 311A transmits information about the channel, program name, number of broadcasts, broadcast date and the like of the contents to the contents identification information delivery server 4A and accesses these. Next, the contents playback section 311A retrieves information about the channel, program name, number of broadcasts, and broadcast date which correspond to the contents, and receives contents identification information which it then associates with the contents and stores in the contents storage section 310A.

Note that in addition to having contents delivered from the contents delivery device 1A, if data recorded on a recording medium such as a DVD is to be read by a terminal device 3, then in the same way, it is possible for contents identification information to be acquired from the contents identification information delivery server 4A using the title and author's name and the like of those contents.

Moreover, in the above described embodiment, if a program is able to be played back, then while a program being broadcast is stored in the contents storage section 31A, it is also possible to receive comments registered during the broadcast, and deliver those comments to a terminal device 3 which is watching the relevant program. By employing this method, it is possible to view a program being broadcast and comment information in real time.

In this manner, in addition to downloading data targeted for playback from a server, it is also possible in cases in which program data received from a broadcast station has been recorded or in which a user is playing contents recorded on a recording medium using a terminal device for comments to be displayed on screen so as to match the data targeted for playback while this data is being played. Namely, it is possible both when the contents are saved on a terminal device 3 and when the contents have been recorded on a recording medium such as a DVD or portable memory for a user to make comments and enjoy viewing contents and comments. As a result, the range of contents capable of being managed can be considerably broadened.

Moreover, in the above described embodiments, it is also possible to perform the comment delivery control and the comment display control by recording on a computer-readable recording medium a program which realizes the functions of the comment delivery server 2 shown in FIG. 2 or a program which realizes the functions of the terminal device 3 shown in FIG. 4 and FIG. 8, and by causing this program recorded on a recording medium to be read and executed by a computer system. It is also possible for a program which realizes the functions of the terminal device 3 shown in FIG. 4 and FIG. 8 to be installed as a plug-in on an existing terminal device 3. Note that, here, the term ‘computer system’ includes the OS and hardware such as peripheral devices and the like.

Moreover, if a WWW system is being utilized, then ‘computer system’ can also include a homepage provider environment (or display environment).

‘Computer readable recording medium’ refers to a storage medium such as a portable medium such as a flexible disc, a magneto-optical disc, ROM, or CD-ROM, or a hard disc incorporated in a computer system or the like. Furthermore, ‘computer readable recording medium’ also includes devices that hold a program dynamically for short periods of time such as communication lines when the program is transmitted via a network such as the Internet or via a communication circuit such as a telephone line, and includes devices which hold a program for a fixed period of time such as the volatile memory incorporated in computer systems which form the servers and clients in the case of the communication lines or networks described above. The above described program may realize a portion of the above described functions or may realize the above described functions in combination with a program which has already been recorded on a computer system.

Embodiments of this invention have been described in detail above with reference made to the drawings, however, the specific structure of this invention is not limited to these embodiments and other designs and the like are also included insofar as they do not depart from the spirit or scope of this invention.

### INDUSTRIAL APPLICABILITY

The present invention can be favorably applied to comment delivery systems which attach comments to music and contents and the like via the Internet, however, the present invention is not limited to this.

1. A comment delivery system comprising a comment delivery server which delivers comments relating to music and a terminal device,
the comment delivery server comprising:
a comment information storage section which stores, as comment information, comment contents and a comment attachment time which represents the time when the comment contents are attached by using an elapsed music playback time from the time when playback of the piece of music started, the comment information being stored in association with music identification information for a piece of music;
a music identification information receiving section which receives the music identification information transmitted from the terminal device;
a comment information reading section which reads from the comment information storage section comment information associated with the music identification information which is received by the music identification information receiving section; and
a comment information delivery section which delivers the comment information read by the comment information reading section to the terminal device which transmits the music identification information, and
the terminal device comprising:
a music identification information transmitting section which transmits the music identification information for a piece of music targeted for playback to the comment delivery server;
a comment information receiving section which receives the comment information transmitted from the comment delivery server;
a comment information storage section which stores the comment information received by the comment information receiving section; and
a display unit which displays the comment contents associated with a point in time indicated by the comment attachment time based on the comment information stored in the comment information storage section so as to be synchronized with the elapsed music playback time of the piece of music being played.

2. The comment delivery system according to claim 1, wherein the music identification information is either one of identification information stipulated on the basis of waveform information formed by audio components contained in the piece of music, or identification information obtained by combining the title of the piece of music and artist name of the piece of music.

3. The comment delivery system according to claim 1, wherein,
the comment delivery server stores comment information in the comment information storage section when this comment information is transmitted from the terminal device, and delivers the comment information to the terminal device using the comment information delivery section, and
the terminal device receives the comment information via the comment information receiving section each time this comment information is transmitted from the comment information delivery section, and then stores the comment information in the comment information storage section, and then reads and displays the comment information in accordance with the elapsed music playback time of the music.

4. A comment delivery system comprising a comment delivery server which delivers comments relating to contents and a terminal device,
the comment delivery server comprising:
a comment information storage section which stores, as comment information, comment contents and a comment attachment time which represents the time when the comment contents are attached by using an elapsed contents playback time from the time when playback of the contents started, the comment information being stored in association with contents identification information for contents;
a contents identification information receiving section which receives the contents identification information transmitted from the terminal device;
a comment information reading section which reads from the comment information storage section comment information associated with the contents identification information which is received by the contents identification information receiving section; and
a comment information delivery section which delivers the comment information read by the comment information reading section to the terminal device which transmits the contents identification information, and
the terminal device comprising:
a contents identification information transmitting section which transmits the contents identification information for contents targeted for playback to the comment delivery server;
a comment information receiving section which receives the comment information transmitted from the comment delivery server;
a comment information storage section which stores the comment information received by the comment information receiving section; and
a display unit which displays the comment contents associated with a point in time indicated by the comment attachment time based on the comment information stored in the comment information storage section so as to be synchronized with the elapsed contents playback time of the contents being played.

5. The comment delivery system according to claim 4, wherein
the contents are program data broadcast from a broadcasting station, and
the contents identification is program identification information which identifies the program data, and which is transmitted together with the program data.

6. The comment delivery system according to claim 4, wherein
the contents are moving picture data which is read from a recording medium by the terminal device, or is received from a moving picture data delivery server by the terminal device, and
the contents identification includes a title of the moving picture data.

7. A terminal device in a comment delivery system comprising a comment delivery server which delivers comments relating to music and the terminal device,
the terminal device comprising:
a music identification information transmitting section which transmits the music identification information for a piece of music targeted for playback to the comment delivery server;
a comment information receiving section which receives from the comment delivery server comment information including comment contents and a comment attachment time which represents the time when the comment contents are attached by using an elapsed music playback time from the time when playback of the music started, the comment information being created in association with the music identification information for the piece of music;
a comment information storage section which stores the comment information received by the comment information receiving section; and
a display unit which displays the comment contents associated with a point in time indicated by the comment attachment time based on the comment information stored in the comment information storage section so as to be synchronized with the elapsed music playback time of the piece of music being played.

8. The terminal device according to claim 7, further comprising:
a music data storage section which stores music data for the piece of music and the music data identification information which identifies the piece of music in association therewith; and
a music playback section which reads and plays music data stored in the music data storage section,
wherein the display unit displays the comment contents which correspond to the elapsed music playback time of the music data being played by the music playback section.

9. A terminal device in a comment delivery system comprising a comment delivery server which delivers comments relating to contents and the terminal device,
the terminal device comprising:
a contents identification information transmitting section which transmits the contents identification information for contents targeted for playback to the comment delivery server;
a comment information receiving section which receives from the comment delivery server comment information including comment contents and a comment attachment time which represents the time when the comment contents are attached by using an elapsed contents playback time from the time when playback of the contents started, the comment information being created in association with the contents identification information for the contents;
a comment information storage section which stores the comment information received by the comment information receiving section; and
a display unit which displays the comment contents associated with a point in time indicated by the comment attachment time based on the comment information stored in the comment information storage section so as to be synchronized with the elapsed contents playback time of the contents being played.

10. A comment delivery method in a comment delivery system having a comment delivery server which delivers comments relating to music and a terminal device,
the comment delivery method in the comment delivery server comprising:
receiving music identification information for a piece of music transmitted from the terminal device;
reading comment information which corresponds to the received music identification information from a comment information storage section which stores, as the comment information, comment contents and a comment attachment time which represents the time when the comment contents are attached by using an elapsed music playback time from the time when playback of the piece of music started, the comment information being stored in association with music identification information for the piece of music; and
delivering the read comment information to the terminal device which transmitted the music identification information, and
the comment delivery method in the terminal device comprising:
transmitting the music identification information for a piece of music targeted for playback to the comment delivery server;
receiving the comment information transmitted from the comment delivery server and storing the comment information in a comment information storage section; and,
based on the comment information stored in the comment information storage section, displaying the comment contents associated with a point in time indicated by the comment attachment time so as to be synchronized with the elapsed music playback time of the piece of music being played.

11. A comment delivery method in a comment delivery system having a comment delivery server which delivers comments relating to contents and a terminal device,
the comment delivery method in the comment delivery server comprising:
receiving contents identification information for the contents transmitted from the terminal device;
reading comment information which corresponds to the received contents identification information from a comment information storage section which stores, as the comment information, comment contents and a comment attachment time which represents the time when the comment contents are attached by using an elapsed contents playback time from the time when playback of the contents started, the comment information being stored in association with contents identification information for the contents; and
delivering the read comment information to the terminal device which transmitted the contents identification information, and
the comment delivery method in the terminal device comprising:
transmitting the contents identification information for contents targeted for playback to the comment delivery server;
receiving the comment information transmitted from the comment delivery server and storing the comment information in a comment information storage section; and,
based on the comment information stored in the comment information storage section, displaying the comment contents associated with a point in time indicated by the comment attachment time so as to be synchronized with the elapsed contents playback time of the contents being played.

12. A computer readable recording medium storing a program which causes to be executed on a computer of a terminal device of a comment delivery system having a comment delivery server which delivers comments relating to music, and the terminal device:
a music identification information transmitting function in which the music identification information for a piece of music targeted for playback is transmitted to the comment delivery server;
a comment information receiving function in which comment information including comment contents and a comment attachment time which represents the time when the comment contents are attached by using an elapsed music playback time from the time when playback of the music started is received from the comment delivery server, the comment information being created in association with the music identification information for the piece of music;
a storage function in which the comment information received when the comment information receiving function was performed is stored in a comment information storage section; and
a display function in which, based on the comment information stored in the comment information storage section, the comment contents associated with a point in time indicated by the comment attachment time are displayed so as to be synchronized with the elapsed music playback time of the piece of music being played.

13. A computer readable recording medium storing a program which causes to be executed on a computer of a terminal device of a comment delivery system having a comment delivery server which delivers comments relating to contents, and the terminal device:
a contents identification information transmitting function in which the contents identification information for contents targeted for playback is transmitted to the comment delivery server;
a comment information receiving function in which comment information including comment contents and a comment attachment time which represents the time when the comment contents are attached by using an elapsed contents playback time from the time when playback of the contents started is received from the comment delivery server, the comment information being created in association with the music identification information for the contents;
a storage function in which the comment information received when the comment information receiving function was performed is stored in a comment information storage section; and
a display function in which, based on the comment information stored in the comment information storage section, the comment contents associated with a point in time indicated by the comment attachment time are displayed so as to be synchronized with the elapsed contents playback time of the contents being played.
